(19) United States
(12) Patent Application Publication
(10) Pub. No.: US 2018/0316709 A1
(43) Pub. Date: Nov. 1, 2018

(54) SYSTEM AND METHOD FOR DETECTING REGULATORY ANOMALIES WITHIN ELECTRONIC COMMUNICATION

(71) Applicant: NURO Secure Messaging Ltd., Tel Aviv (IL)

(72) Inventor: Eliyahu PURIAN, Tel Aviv (IL)

(73) Assignee: NURO Secure Messaging Ltd., Tel Aviv (IL)

(21) Appl. No.: 15/964,813

(22) Filed: Apr. 27, 2018

Related U.S. Application Data
(60) Provisional application No. 62/491,446, filed on Apr. 28, 2017.

(51) Int. Cl. H04L 29/06; G06F 15/18; G06F 17/27; G06T 7/00

(52) U.S. Cl. CPC H04L 63/1425; H04L 63/0245; G06T 7/0002; G06F 17/27; G06F 15/18

(57) ABSTRACT

A system and method for detecting a regulatory anomaly within electronic communication between end-point devices over a network. The method includes: monitoring electronic communication between a first device and at least a second device over the network; identifying content and metadata associated with the electronic communication; analyzing the electronic communication based on the identified content and metadata; detecting regulatory anomalies within the electronic communication based on the analysis of the content and metadata of the electronic communication, wherein the regulatory anomaly is determined based on at least a set of organization rules; and generating a notification when the regulatory anomaly is detected.

### CROSS-REFERENCE TO RELATED APPLICATIONS

This application claims the benefit of U.S. Provisional Application No. 62/491,446 filed on Apr. 28, 2017, the contents of which are hereby incorporated by reference.

### TECHNICAL FIELD

The present disclosure relates generally to communication monitoring, and more specifically to a method and system of monitoring electronic communication to detect anomalies that violated regulatory requirements.

### BACKGROUND

Electronic communication has quickly become a default mode of interacting with others, specifically within an organizational or corporate environment. Team members, supervisors, employees, clients, and other professionals all employ various forms of electronic communication, including emails, instant messages, SMS messages, voice messages, and the like. These can be made using personal computers, smartphones, tablets, wearables, and various other devices capable of sending and receiving electronic messages. The ease with which people are able to communicate has also contributed in increased in the volume and frequency of such communication.

At the same time, many companies must monitor the communication that happens both internally as well as with individuals outside their institution. Many companies and organizations must enforce internal guidelines, such as regulating company policy, as well as ensure that external regulations, such as privacy laws, are properly implemented. For example, increased scrutiny of communications is often required in heavily regulated industries such as financial services and healthcare. For other companies, e.g., those affected by the rash of accounting scandals in the 2000s, must abide by and implement the Sarbanes-Oxley Act, which implemented a set of rules that enhance corporate responsibility, enhance financial disclosures and combat corporate and accounting fraud. Others must satisfy the Dodd-Frank Wall Street Reform and Consumer Protection Act of 2010, which set out to tighten the regulatory system regarding, among other topics, consumer protection, trading restrictions, and the regulation of financial products.

In light of increased internal and external monitoring requirements, many organizations now include a position of a chief compliance officer (CCO), who is an officer primarily responsible for overseeing and managing regulatory compliance issues within the organization. The CCO typically reports to the Chief Executive Officer or Chief Operations Officer. The CCO position often includes leading enterprise compliance efforts, designing and implementing internal controls, policies and procedures to assure compliance with applicable local, state and federal laws and regulations and third-party guidelines; managing audits and investigations into regulatory and compliance issues; and responding to requests for information from regulatory bodies.

However, effectively reviewing the increased number of electronic communications can be unwieldy and impractical, especially if it requires one or more employees to manually screen each and every piece of communication. One solution may include only reviewing a few sample communications, but this can lead to violating messages being let through. Further, certain mistakes can easily slip by a human operator, such as comparing the required level of security clearance of documents with the level granted to an intended recipient where to potential recipients have similar names. Thus, the more the number of communications increases, the more difficult it is to meet the requisite compliance requirements.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include a method for detecting a regulatory anomaly within electronic communication between end-point devices over a network, including: monitoring electronic communication between a first device and at least a second device over the network; identifying content and metadata associated with the electronic communication; analyzing the electronic communication based on the identified content and metadata; detecting regulatory anomalies within the electronic communication based on the analysis of the content and metadata of the electronic communication, wherein the regulatory anomaly is determined based on at least a set of organization rules; and generating a notification when the regulatory anomaly is detected.

Certain embodiments disclosed herein also include a non-transitory computer readable medium having stored thereon instructions for causing a processing circuitry to perform a process, the process including: monitoring electronic communication between a first device and at least a second device over the network; identifying content and metadata associated with the electronic communication; analyzing the electronic communication based on the identified content and metadata; detecting regulatory anomalies within the electronic communication based on the analysis of the content and metadata of the electronic communication, wherein the regulatory anomaly is determined based on at least a set of organization rules; and generating a notification when the regulatory anomaly is detected.

Certain embodiments disclosed herein also include a system for detecting a regulatory anomaly within electronic communication between end-point devices over a network, comprising: a processing circuitry; and a memory, the memory containing instructions that, when executed by the processing circuitry, configure the system to: monitor electronic communication between a first device and at least a second device over the network; identify content and metadata associated with the electronic communication; analyzing the electronic communication based on the identified content and metadata; detect regulatory anomalies within the electronic communication based on the analysis of the content and metadata of the electronic communication, wherein the regulatory anomaly is determined based on at least a set of organization rules; and generate a notification when the regulatory anomaly is detected.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram of a system for monitoring electronic communication between end point devices according to an embodiment.

FIG. 2 is a block diagram of the monitoring server according to an embodiment.

FIG. 3 is a flowchart of a method for identifying anomalies within electronic communication according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for detecting anomalies within electronic communication sent between end-point devices (EPDs) over a network. The system includes an administrator server and a monitoring server as well as to a plurality of end point devices (EPDs), collectively connected to the network. In an embodiment, each EPD includes an agent installed locally thereon that may be associated with an organization's employees.

According to some example embodiments, upon receiving a request to send a certain electronic communication from a first EPD to a second EPD, e.g., via a natively installed agent, the request is analyzed by the administrator server and the monitoring server to determine if the electronic communication breaches internal or external rules or regulations, i.e., if an anomaly is identified. A notification may be generated if a breach is detected and sent to the sender or a designated individual, and transmission of the communication may be prevented from completion. According to an embodiment, the detection of the breach may use machine learning techniques or using set of rules (saved in a database), as discussed herein below.

A web bot, also known as web robot, is a software application that is capable of running automated tasks, e.g., executing scripts, over a network. Typically, web bots perform tasks that are both simple and structurally repetitive, at a much higher rate than would be possible for a human alone. The largest use of web bots is in web spidering (web crawler), in which an automated script fetches, analyzes and files information from web servers at many times the speed achievable by a human. More than half of all web traffic is made up of such bots.

In an embodiment, the method includes a web bot configured to monitor communication and collaboration within an organization's environment. Based on the monitoring, and a predefined set of rules, the web bot is configured to identify inappropriate or unauthorized communication and provide alerts respective thereof. The alerts may be customized based on the type of the inappropriate or unauthorized communication.

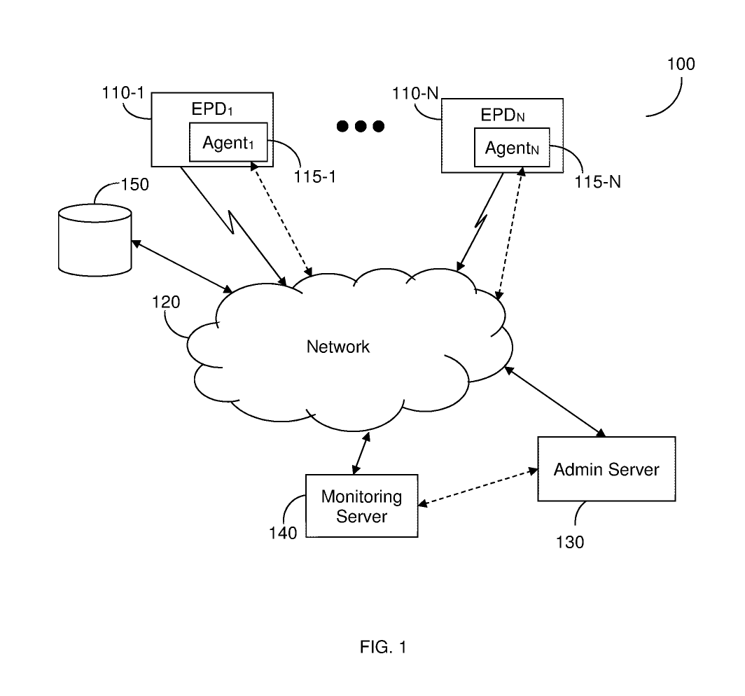

FIG. 1 is an example network diagram of a system 100 for detection of regulatory or rule breaching communication between EPDs 110 according to an embodiment. The system 100 enables the detection of anomalies as further described below, and may further enable the customization of notifications based on any detected anomalies.

A plurality of EPD 110-1 through 110-N (collectively referred hereinafter as EPDs 110 or individually as an EPD 110, merely for simplicity purposes), where N is an integer equal to or greater than 1, are connected to an enterprise's network 120. The EPDs 110 may be, but are not limited to, smartphones, mobile phones, laptops, tablet computers, personal computers (PCs), wearable computing devices, or any other device capable of sending and receiving communication data.

Each of the EPDs 110-1 through 110-N has an agent installed therein, 115-1 through 115-N respectively (collectively referred hereinafter as agents 115 or individually as an agent 115, merely for simplicity purposes). Each of the agents 115 may be implemented as an application program having instructions that may reside in a memory (not shown) of a respective EPD 110. The application program may be software, which shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions cause a processing circuitry (not shown) within an EPD 110 to perform the various processes described herein. Specifically, the instructions, when executed, cause the EPD to send and receive electronic communication and notifications over the network 120 to an intended recipient. Note that in one embodiment an ultimate intended recipient may be located outside of the network 120, e.g., where an intermediate recipient between the sender and the ultimate intended recipient is located within the network.

The network 120 may include a local area network (LAN), an intranet, a wide area network (WAN), the worldwide web (WWW), the Internet, as well as a variety of other communication networks, whether wired or wireless, and in any combination, that enable the transfer of data between the different elements of the system 100.

An administrator server 130 is further connected to the network 120. The administrator server 130 is configured to receive and send data or content via the network 120, e.g., between one or more of the EPDs 110. The administrator server 130 includes a memory and processing circuitry (not shown) and may be operated by a representative or employee of the organization.

The administrator server 130 is further connected to a monitoring server 140. In one embodiment, the administrator server 130 is directly connected to the monitoring server 140, and in another embodiment the administrator server 130 is connected to the monitoring server 140 over the network 120. The monitoring server 140 is configured to receive and monitor communication and communication requests from one or more EPDs 110. According to the embodiments disclosed herein, a first EPD, for example, the EPD 110-1, to can securely communicate with at least a second EPD, e.g., EPD 110-2 over the network 120.

The system 100 further includes a database 150. The database 150 is configured to store therein information associated with the organization's rules, policies, and/or regulations (collectively referred hereinafter as the “organization rules”) that may be received from the administrator server 130 or from an external resource, e.g., a government website. For example, the database 150 may include a listing of certain security level clearances that each EPD 110 is assigned, a listing of which EPDs 110 are authorized to communicated with which other EPDs 110, a list of words that are deemed to be inappropriate language, and the like. In an embodiment, the database 150 may change or be updated from time to time.

A monitoring server 140 is further connected to the network 120 and is configured to monitor electronic communication between EPDs. The electronic communication may be, for example, an email, an SMS message, an MMS message, a voice message, an instant message, a file sharing request, a combination thereof, and the like. The electronic communication may include content and metadata, and may contains only text, only images, both text and images, links to external references, and the like. Recipient data may be included in the metadata of content, and may include, for example, a recipient name, title, department, email address, phone number, username, associated user device or devices, and the like.

In an embodiment, the content and metadata are identified by the monitoring server 140 to determine if any anomalies have been detected. The determination may include one or more machine learning techniques, computer vision techniques, artificial intelligence, a combination thereof, and the like. The analysis may include matching the content or metadata of the electronic communication to similar reference content or metadata, e.g., stored on the database, and determining similar characteristics between the current communication and the reference data.

According to an embodiment, the system 100 allows each EPD 110, for example, the

EPD 110-1, to securely communicate with at least a second EPD. The monitoring server 140 is configured to continuously monitor electronic communication that passes through the network 120.

Based on the monitoring, the monitoring server 140 is configured to identify content and metadata associated with the communication. The metadata may be, for example, a type of communication, content, target request, title, recipient data, instructions received from the first EPD 110-1, a combination thereof, and the like. The type may be, for example, whether the communication is an email, an SMS, and the like. The content may include identification of which file was sent, a text of a message, and the like. The recipient data may include, for example, recipient name, title, department, email address, phone number, and the like. The metadata and content are analyzed, which may include one or more machine learning techniques, one or more computer vision techniques, a combination thereof, and the like.

Based on the analysis of the metadata and content, it is determined if at least one compliance anomaly is detected. A compliance anomaly corresponds to a breach of at least one of a predetermined set of organization rules that may be stored in and accessed from the database 150. The predetermined set of organization rules may include, for example, terms that are deemed to be inappropriate in communication between employees, data leakage, i.e., indications of data being sent to an unauthorized entity, data having a security level sent to a recipient without authority to view such data, a message indicating that it is intended for a first recipient but addressed to a second recipient, and the like. In an embodiment, the organization rules may be accessed from the database 150 by the administrator server 130, where the monitoring server 140 receives relevant regulatory information from the administrator server 130.

Upon identification of at least one compliance anomaly, a notification may be generated. The notification may include, for example, an alert sent to one or more of the participants of the electronic communication in which the anomaly has been identified, a notification sent to the administrator server 130 indicative of the anomaly, an alert sent to a predetermined supervising officer, and so on. According to an embodiment, an action is taken based on the detection of an anomaly, for example, preventing the transmission of the communication to the intended recipient.

As a non-limiting example, upon receiving a request to send an outgoing email from a first end point device 110 to an account manager in the organization named John Smith, the request is analyzed and metadata associated thereto is identified. The email is then scanned for security validation. Thereafter, it is determined whether a compliance anomaly detected. The compliance anomaly may be, for example, that the first line of the email includes the words “Dear Rebecca”, indicating that the email may not be addressed to the intended contact.

As another example, it may be identified that the email contains text or attachments that include confidential information that the recipient, John Smith, lacks the clearance to view based on a predetermined set of organization rules. According to another example, the email may include inappropriate language as per a company policy predetermined within the organizational environment. Upon identification of a compliance anomaly, a notification is generated and an alert is provided, e.g., to the sender, the intended recipient, the administrator server, a supervisor, any combination thereof, and the like. In an embodiment, transmission of the communication is blocked by the monitoring server 140.

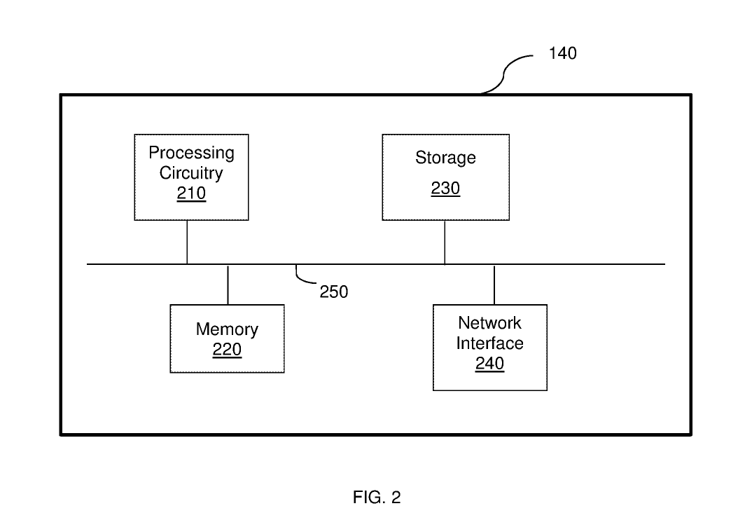

FIG. 2 is an example block diagram of the monitoring server 140 according to an embodiment. The monitoring server 140 includes a processing circuitry 210 connected to a memory 220 and a network interface 240 via a bus 250. The processing circuity 210 is configured to monitor communication from one EPD 110 to another over the network 120 via the network interface 240 and may be further configured to analyze the content and metadata of an associated communication. The network interface 240 may include, but is not limited to, a wired interface (e.g., an Ethernet port) or a wireless port (e.g., an 802.11 compliant WiFi card) configured to connect to the network 120. The network interface 240 allows the monitoring server 140 to communicate with the rest of the system 100 in order to monitor and view electronic communication.

The processing circuitry 210 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), general-purpose microprocessors, microcontrollers, digital signal processors (DSPs), and the like, or any other hardware logic components that can perform calculations or other manipulations of electronic data.

The memory 230 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing circuitry 210 to perform the various processes described herein. Specifically, the instructions, when executed, cause the processing circuitry 210 to perform an analysis of an electronic communication to identify the presence of an anomaly to detect the presence of a breach of organization rules.

In an embodiment, the monitoring server 140 may further include a storage 230, where an application configured to monitor communication may be stored. The storage 230 may be magnetic storage, optical storage, and the like, and may be realized in any medium which can be used to store the desired information. The storage 230 may store communication requests associated with one or more EPDs.

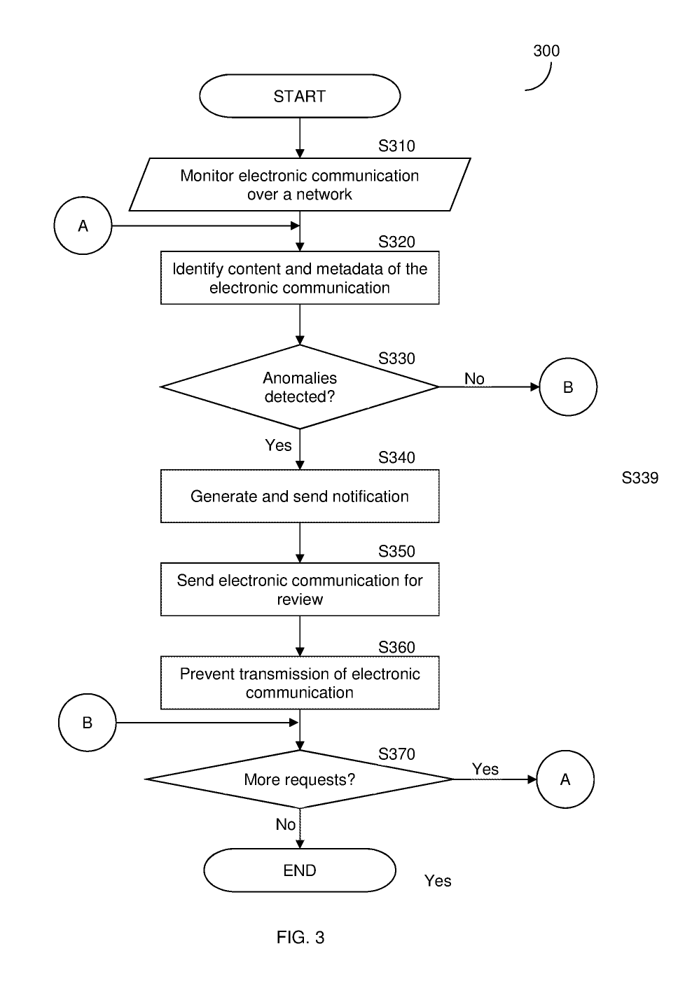

FIG. 3 is an example flowchart of a method 300 for identifying anomalies within electronic communications according to an embodiment. At S310, electronic communication over a network is monitored. The electronic communication may include communication between EPDs within the network, or between an EPD within the network with a recipient device outside of the network. The electronic communication may include an email, an SMS message, an MMS message, a voice message, an instant message, a file sharing request, a combination thereof, and the like.

At S320, content, metadata, or both, associated with the electronic communication is identified, e.g., by a monitoring server 140. According to an embodiment, the metadata may be identified in conjunction with an agent installed on an EPD 110 or the administrator server 130. The metadata may include, for example, a type of communication, content, target request, title, recipient data, instructions received from a first EPD 110, a combination thereof, and so on. The type may be, for example, whether the communication is an email, an SMS, a file share request, and the like. The content may include identification of which file was sent, a text of a message, multimedia content, and the like. The recipient data may include, for example, recipient name, title, department, email address, phone number, and the like.

At S330, based on an analysis of the content and metadata, it is determined if any anomalies have been detected. Anomalies includes a breach of the organizational rules relating to permitted and prohibited communication. An anomaly may include sending a message to an unintended recipient, sending classified information to a recipient not authorized to view such content, text including words or phrases deemed inappropriate, and the like.

According to an embodiment, the analysis may include matching of the content or the metadata to similar content or metadata associated with the EPD or previously analyzed, which may be stored on an accessed from a database. In a further embodiment, the analyzed content and metadata are compared against the set of organization rules stored in the database 150. The analysis may be textual analysis, semantic analysis, and contextual analysis, and the like. According to a further embodiment, the detection of a breach indicative of an anomaly may be based on machine learning techniques.

If no anomaly is detected, execution continues with S370. Otherwise, it proceeds with S340.

At S340, a notification is generated and sent with respect of the detected anomaly. The notification may include an alert notifying a sender of the anomaly, an alert notifying a supervisor of the breach, or a message informing the intended recipient of a failed communication attempt. At optional S350, the outgoing communication content or metadata is sent for review, for example, to an administrator server 130 for review by a supervisor or administrator. At S360, it is checked whether additional requests have been received and if so, execution continues with S320; otherwise, execution terminates.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for detecting a regulatory anomaly within electronic communication between end-point devices over a network, comprising:
monitoring electronic communication between a first device and at least a second device over the network;
identifying content and metadata associated with the electronic communication;
analyzing the electronic communication based on the identified content and metadata;
detecting regulatory anomalies within the electronic communication based on the analysis of the content and metadata of the electronic communication, wherein the regulatory anomaly is determined based on at least a set of organization rules; and
generating a notification when the regulatory anomaly is detected.

2. The method of claim 1, wherein the regulatory anomaly is detected based on a set of predetermined rules.

3. The method of claim 1, further comprising:
preventing the delivery of the electronic communication when the regulatory anomaly is detected.

4. The method of claim 1, further comprising:
sending the notification to at least one of: a sender of the electronic communication, an intended recipient of the electronic communication, an administrator server, and a supervisor.

5. The method of claim 1, further comprising:
sending the electronic communication, when the regulatory anomaly is detected, to at least one of: a sender of the electronic communication, an administrator server, a supervisor.

6. The method of claim 1, wherein the regulatory anomaly comprises a usage of inappropriate language within the electronic communication, and wherein the detection of the inappropriate language is based on comparing the content of the electronic communication to an organization rule defining language determined to be inappropriate.

7. The method of claim 1, wherein the regulatory anomaly comprises a data security breach, including sending secure information to an unauthorized recipient, wherein authorized and unauthorized recipients are determined based on an organization rule.

8. The method of claim 1, wherein the regulatory anomaly comprises the electronic communication being addressed to an unintended recipient.

9. The method of claim 1, wherein the analysis of the electronic communication includes at least one of: textual analysis, image analysis, and contextual analysis.

10. The method of claim 1, wherein the analysis and detection of the regulatory anomaly is performed using a machine learning process.

11. The method of claim 1, wherein the first device and the at least a second device belong to the same organization.

12. A non-transitory computer readable medium having stored thereon instructions for causing a processing circuitry to perform a process, the process comprising:
monitoring electronic communication between a first device and at least a second device over the network;
identifying content and metadata associated with the electronic communication;
analyzing the electronic communication based on the identified content and metadata;
detecting regulatory anomalies within the electronic communication based on the analysis of the content and metadata of the electronic communication, wherein the regulatory anomaly is determined based on at least a set of organization rules; and
generating a notification when the regulatory anomaly is detected.

13. A system for detecting a regulatory anomaly within electronic communication between end-point devices over a network, comprising:
a processing circuitry; and
a memory, the memory containing instructions that, when executed by the processing circuitry, configure the system to:
monitor electronic communication between a first device and at least a second device over the network;
identify content and metadata associated with the electronic communication;
analyzing the electronic communication based on the identified content and metadata;
detect regulatory anomalies within the electronic communication based on the analysis of the content and metadata of the electronic communication, wherein the regulatory anomaly is determined based on at least a set of organization rules; and
generate a notification when the regulatory anomaly is detected.

14. The system of claim 13, wherein the regulatory anomaly is detected based on a set of predetermined rules.

15. The system of claim 13, the system further configured to:
prevent the delivery of the electronic communication when the regulatory anomaly is detected.

16. The system of claim 13, the system further configured to:
send the notification to at least one of: a sender of the electronic communication, an intended recipient of the electronic communication, an administrator server, and a supervisor.

17. The system of claim 13, the system further configured to:
send the electronic communication, when the regulatory anomaly is detected, to at least one of: a sender of the electronic communication, an administrator server, a supervisor.

18. The system of claim 13, wherein the regulatory anomaly comprises a usage of inappropriate language within the electronic communication, and wherein the detection of the inappropriate language is based on comparing the content of the electronic communication to an organization rule defining language determined to be inappropriate.

19. The system of claim 13, wherein the regulatory anomaly comprises a data security breach, including sending secure information to an unauthorized recipient, wherein authorized and unauthorized recipients are determined based on an organization rule.

20. The system of claim 13, wherein the regulatory anomaly comprises the electronic communication being addressed to an unintended recipient.

21. The system of claim 13, wherein the analysis of the electronic communication includes at least one of: textual analysis, image analysis, and contextual analysis.

22. The system of claim 13, wherein the analysis and detection of the regulatory anomaly is performed using a machine learning process.

23. The system of claim 13, wherein the first device and the at least a second device belong to the same organization.
